(19) United States
(12) Patent Application Publication
(10) Pub. No.: US 2026/0177713 A1
(43) Pub. Date: Jun. 25, 2026

(54) DEVICES AND METHODS FOR PASSIVELY DETECTING TUNNEL EXCAVATION ADVERSE GEOLOGY

(71) Applicant: TONGJI UNIVERSITY, Shanghai (CN)

(72) Inventors: Yadong XUE, Shanghai (CN); Feipeng HUANG, Shanghai (CN); Yongfa GUO, Shanghai (CN); Jinjing YANG, Shanghai (CN); Wenyun DING, Shanghai (CN); Guimin LI, Shanghai (CN); Wei LUO, Shanghai (CN); Wei GUAN, Shanghai (CN); Wandong TIAN, Shanghai (CN); Zhibin LUO, Shanghai (CN); Boyan LI, Shanghai (CN)

(73) Assignee: TONGJI UNIVERSITY, Shanghai (CN)

(21) Appl. No.: 19/428,129

(22) Filed: Dec. 20, 2025

(30) Foreign Application Priority Data
Dec. 20, 2024 (CN) 202411893406.7

(51) Int. Cl. G01V 1/16; E21D 9/00; G01V 1/18

(52) U.S. Cl. CPC G01V 1/162; E21D 9/003; G01V 1/181

(57) ABSTRACT

Provided are a device and a method for passively detecting tunnel excavation adverse geology. The device for passively detecting tunnel excavation adverse geology includes a plurality of detection mechanisms. The plurality of detection mechanisms are disposed in a forepoling borehole located at a working face of a tunnel. The plurality of detection mechanisms includes a protection system, a signal acquisition system, a signal transmission system, and an intelligent terminal system. The signal acquisition system is disposed inside the protection system. The protection system is configured to protect the signal acquisition system. The signal acquisition system is connected to the intelligent terminal system through the signal transmission system to transmit acquired signals to the intelligent terminal system for processing.

### CROSS-REFERENCE TO RELATED APPLICATIONS

This application claims priority to the Chinese Patent Application No. 202411893406.7, filed on Dec. 20, 2024, the contents of which are hereby incorporated by reference.

### TECHNICAL FIELD

The present disclosure generally relates to the field of geological detection technology in tunnel construction, and in particular to a device and a method for passively detecting tunnel excavation adverse geology.

### BACKGROUND

Due to various factors such as terrain, geology, and climate conditions, a series of geological risk hazards often occur during tunnel excavation, including water inrush, mud gushing, fractured zones, rockbursts, freeze-thaw and frost heaving, with water inrush being the most common risk. If these risks are not warned and handled timely, the safety and progress of tunnel construction may be severely compromised.

Tunnel water inrush is mostly related to the surrounding geological structures and precipitation conditions during construction. When the tunnel excavation reaches strata containing geological structures such as faults, fractures, and karst caves, water inrush channels are easily formed. If the construction site encounters drastic changes in precipitation conditions, a water inrush accident may also be triggered. The water inrush adversely affects the construction process in several ways. Small water inrush deteriorates the on-site construction environment and reduces the efficiency of support work. Large water inrush may submerge equipment and construction workers, delay the construction progress, increase construction costs, and, in severe cases, cause casualties. The water inrush may bring changes in groundwater levels, affecting the surrounding ecological environment. In addition, the sediment and wastewater carried during the water inrush may pollute surrounding water bodies and soil. Therefore, timely and effective detection of water bodies ahead of the tunnel under construction is of great significance for ensuring safe and stable construction.

Advanced geological prediction can obtain information about the surrounding rock mass ahead of the working face in advance for preventing disasters. Existing seismic detection for advanced geological prediction technologies is mostly based on a full-space seismic wave field propagation model, and employs an observation system arranged on the tunnel wall to obtain information ahead. However, the actual tunnel space is disturbed by free interfaces such as the working face and tunnel walls, and does not fully comply with the full-space wave field propagation law. Consequently, detection methods based on the full-space model are prone to false detection and missed detection. Arranging the observation system on the tunnel wall is time-consuming, costly, and offers poor repeatability, which is not suitable for a plurality of detections. At present, anomaly imaging and interpretation are performed manually. When dealing with excessive data volumes, this approach results in a prolonged imaging cycle, high costs, significant susceptibility to human bias, and pronounced interpretive non-uniqueness.

Existing devices and methods for detecting adverse geology still suffer from numerous issues during the detection process, including cumbersome equipment installation and operation, severe attenuation and diffusion of reflected waves, and poor signal reception. These issues adversely affect both detection efficiency and accuracy.

### SUMMARY

An objective of the present disclosure is to provide a device for passively detecting tunnel excavation adverse geology and a detection method, solving the problems of complex structure, inconvenient use, and low detection accuracy of existing devices.

To achieve the above objective, the present disclosure provides a device for passively detecting tunnel excavation adverse geology. The device for passively detecting tunnel excavation adverse geology includes a plurality of detection mechanisms, the plurality of detection mechanisms is disposed in a forepoling borehole located at a working face of a tunnel. The plurality of detection mechanisms includes a protection system, a signal acquisition system, a signal transmission system, and an intelligent terminal system. The signal acquisition system is disposed inside the protection system, the protection system is configured to protect the signal acquisition system. The signal acquisition system is connected to the intelligent terminal system through the signal transmission system, and transmits an acquired signal to the intelligent terminal system for processing. The protection system includes a plurality of detection sleeves connected end to end and a magnetic attraction sleeve for conveying the plurality of detection sleeves into the forepoling borehole. Each of the plurality of detection sleeves is provided with a mounting hole for allowing the signal acquisition system to extend out of a corresponding detection sleeve. Each of the plurality of mounting holes is provided with a cover for sealing a corresponding mounting hole. An interior of each of the plurality of detection sleeves is provided with a driving element for driving a corresponding cover to open or close the corresponding mounting hole, and the driving element is connected to the intelligent terminal system. One end of the magnetic attraction sleeve is provided with a connector, and the magnetic attraction sleeve is connected to the plurality of detection sleeves through the connector. The magnetic attraction sleeve is provided with a switch structure for controlling connection or disconnection between the connector and the plurality of detection sleeves.

The technical solutions of the present disclosure are further described in detail below through the accompanying drawings and embodiments.

### BRIEF DESCRIPTION OF THE DRAWINGS

FIG. 1 is a schematic diagram illustrating a structure of a device for passively detecting tunnel excavation adverse geology in an application state according to some embodiments of the present disclosure.

FIG. 2 is a schematic diagram illustrating a structure of a protection system according to some embodiments of the present disclosure.

FIG. 3 is a schematic diagram illustrating a partial cross-sectional structure of a detection sleeve according to some embodiments of the present disclosure.

FIG. 4 is a schematic diagram illustrating a structure of a magnetic attraction sleeve according to some embodiments of the present disclosure.

FIG. 5 is a schematic diagram illustrating a structure of an end of a detection sleeve according to some embodiments of the present disclosure.

FIG. 6 is a schematic diagram of a connection between a signal transmission system and a probe according to some embodiments of the present disclosure.

FIG. 7 is a schematic block diagram of an intelligent terminal system according to some embodiments of the present disclosure.

FIG. 8 is a flowchart illustrating a detection method according to some embodiments of the present disclosure.

FIG. 9 is a schematic diagram illustrating an HSP manner according to some embodiments of the present disclosure.

FIG. 10 is an XOY cross-sectional diagram illustrating an analysis result of a reflected wave according to some embodiments of the present disclosure.

FIG. 11 is a schematic diagram illustrating rock mass quality determination according to some embodiments of the present disclosure.

### REFERENCE SIGNS

1. tunnel; 2. detection device; 20. detection mechanism; 31. incident wave signal; 32. reflected wave signal; 4. working face; 5. forepoling borehole; 6. seismic wave signal; 7. adverse geology; 21. protection system; 211. detection sleeve; 212. mounting hole; 213. cover; 214. buckle; 215. slot; 216. magnetic attraction sleeve; 2161. switch structure; 21611. coil; 21612. battery; 21613. switch; 217. handle; 218. connector; 219. driving element; 22. signal acquisition system; 220, 220-1, 220-2. geophone; 221. probe; 222. protective shell; 2221. metal interface; 223. projection ring; 224. groove; 225. base; 226. mounting groove; 227. battery pack; 228. lifting element; 229. wire; 23. signal transmission system; 231. storage unit; 232. antenna; 233. signal transmission line; 234. quick plug connector; 24. intelligent terminal system.

### DETAILED DESCRIPTION

In the description of the present disclosure, it should be noted that the orientation or positional relationships indicated by terms such as “upper,” “lower,” “inner,” “outer,” etc., are based on the orientation or positional relationships shown in the accompanying drawings, or the orientation or positional relationships in which the product of the present disclosure is conventionally placed during use. These terms are used merely to facilitate the description of the present disclosure and simplify the description, and do not indicate or imply that the referred apparatus or element must have a specific orientation or be constructed and operated in a specific orientation. Therefore, they should not be construed as limiting the present disclosure. In the description of the present disclosure, it should also be noted that, unless otherwise explicitly specified and defined, the terms “set,” “mount,” and “connect” should be interpreted broadly. For example, a connection may be a fixed connection, a detachable connection, or an integral connection. It may be a mechanical connection, an electrical connection, or a direct connection. It may also be a connection through an intermediate medium, or an internal communication between two elements. Those skilled in the art can understand the specific meanings of the above terms in the present disclosure based on specific situations.

In the present disclosure, unless otherwise defined, all technical and scientific terms used herein have the same meanings as commonly understood by a person skilled in the art to which the present disclosure pertains. In case of any inconsistency, the meanings as explained in the present disclosure or derived from the content recorded in the present disclosure shall prevail. In addition, the terms used herein are for the purpose of describing the embodiments of the present disclosure and are not intended to limit the present disclosure.

To accurately describe the technical content of the present disclosure and to accurately understand the present disclosure, the following explanations or definitions of the terms used in the present disclosure are provided before describing the specific embodiments:

Drilling and blasting manner: refers to a rock excavation manner involving drilling, charging, and blasting, abbreviated as the drilling and blasting manner. The drilling and blasting manner is the primary construction manner for rock excavation in underground structures.

Water inrush: also known as water burst, refers to a phenomenon of a sudden and massive inflow of groundwater that occurs during the construction of underground chambers or tunnels when passing through areas with developed karst caves, especially when encountering underground river systems, thick water-bearing sand and gravel layers, and large fracture zones connected to surface water.

Geophone: the geophone is a device for detecting certain useful information in a wave signal. The geophone is a device used to identify the presence or variations of waves, oscillations, or signals.

Working face: the working face refers to the exposed top rock surface during tunnel excavation. It is a professional term in tunnel engineering.

Seismic wave: the seismic wave is a wave phenomenon generated when underground rocks fracture or vibrate, propagating energy through the Earth's interior. This wave can transmit energy and cause vibrations.

The embodiments of the present disclosure are described in detail below with reference to the accompanying drawings.

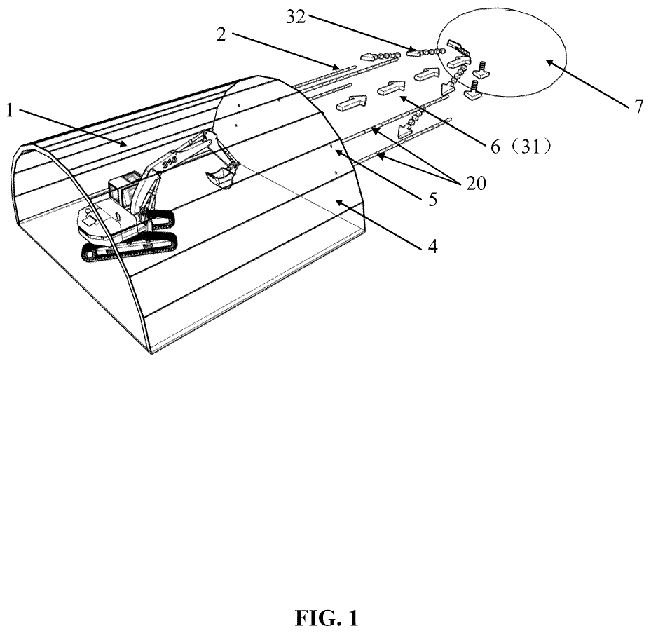

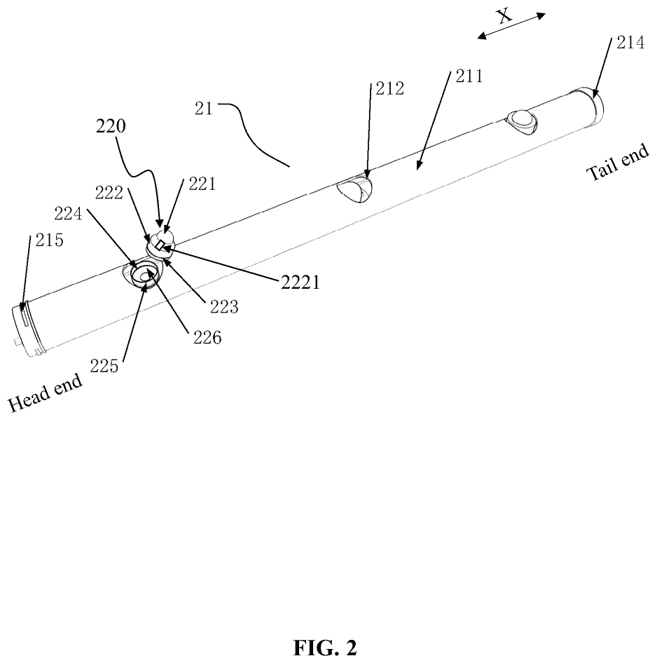

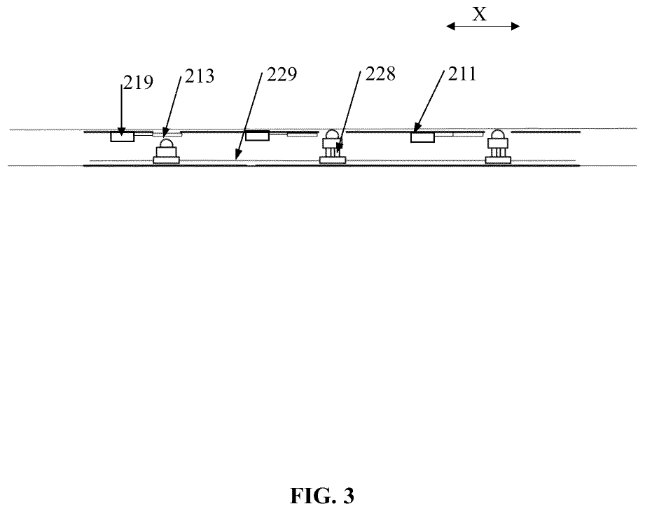

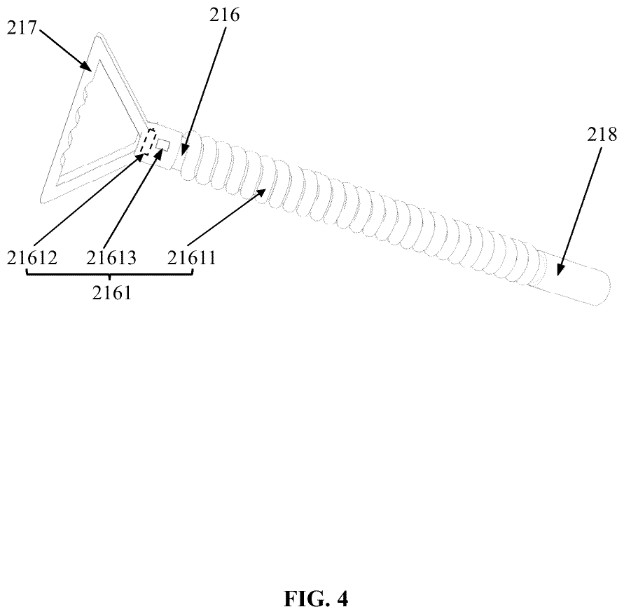

FIG. 1 is a schematic diagram illustrating a structure of a device for passively detecting tunnel excavation adverse geology in an application state according to some embodiments of the present disclosure. FIG. 2 is a schematic diagram illustrating a structure of a protection system according to some embodiments of the present disclosure. FIG. 3 is a schematic diagram illustrating a partial cross-sectional structure of a detection sleeve according to some embodiments of the present disclosure. FIG. 4 is a schematic diagram illustrating a structure of a magnetic attraction sleeve according to some embodiments of the present disclosure.

In some embodiments, as shown in FIG. 1 to FIG. 4, a device for passively detecting tunnel excavation adverse geology 2 (also referred to as the detection device 2) includes a plurality of detection mechanisms 20. The plurality of detection mechanisms 20 is disposed in a forepoling borehole 5 located at a working face 4 of a tunnel 1. The plurality of detection mechanisms 20 include a protection system 21, a signal acquisition system 22, a signal transmission system (e.g., the signal transmission system 23 described below), and an intelligent terminal system (e.g., the intelligent terminal system 24 described below). The signal acquisition system 22 is disposed inside the protection system 21. The protection system 21 is configured to protect the signal acquisition system 22. The signal acquisition system 22 is connected to the intelligent terminal system through the signal transmission system, and transmits an acquired signal to the intelligent terminal system for processing. The protection system 21 includes a plurality of detection sleeves 211 connected end to end and a magnetic attraction sleeve 216 for conveying the plurality of detection sleeves 211 into the forepoling borehole 5. The plurality of detection sleeves 211 are provided with a plurality of mounting holes 212 for allowing the signal acquisition system 22 to extend out of the plurality of detection sleeves 211. The plurality of mounting holes 212 are provided with a plurality of covers 213 for sealing the plurality of mounting holes 212. An interior of the plurality of detection sleeves 211 is provided with a plurality of driving elements 219 for driving the plurality of covers 213 to open or close the plurality of mounting holes 212, and the plurality of driving elements 219 are connected to the intelligent terminal system. One end of the magnetic attraction sleeve 216 is provided with a connector 218, the magnetic attraction sleeve 216 is connected to the plurality of detection sleeves 211 through the connector 218. The magnetic attraction sleeve 216 is provided with a switch structure 2161 for controlling connection or disconnection between the connector 218 and the plurality of detection sleeves 211. The plurality of detection sleeves 211, the plurality of mounting holes 212, the plurality of covers 213, and the plurality of driving elements 219 correspond one-to-one with each other. That is, one detection sleeve corresponds with one mounting hole, one cover, and one driving element.

The device for passively detecting tunnel excavation adverse geology 2 includes a plurality of detection mechanisms 20. The plurality of detection mechanisms 20 is disposed in the forepoling borehole 5 at the working face 4 of the tunnel 1.

The present disclosure utilizes existing forepoling borehole 5 left by advanced drilling to arrange the plurality of detection mechanisms 20, eliminating the need for additional on-site drilling work, improving detection efficiency, and reducing labor.

The plurality of detection mechanisms 20 include the protection system 21, the signal acquisition system 22, the signal transmission system, and the intelligent terminal system.

The signal acquisition system 22 is disposed inside the protection system 21. The protection system 21 is configured to protect the signal acquisition system 22, ensuring that the signal acquisition system 22 can perform information acquisition at a designated position ahead of the working face 4. The signal acquisition system 22 forms a three-dimensional detection array at the working face 4 and is configured to acquire a seismic wave signal 6. The signal acquisition system 22 is connected to the intelligent terminal system through the signal transmission system, and transmits the acquired signal to the intelligent terminal system for processing.

The protection system 21 includes the plurality of detection sleeves 211 connected end to end and the magnetic attraction sleeve 216 for conveying the plurality of detection sleeves 211 into the forepoling borehole 5. The plurality of detection sleeves 211 are provided with the plurality of mounting holes 212 for allowing the signal acquisition system 22 to extend out of the plurality of detection sleeves 211. The plurality of mounting holes 212 are provided with the plurality of covers 213 for sealing the plurality of mounting holes 212. The interior of the plurality of detection sleeves 211 is provided with the plurality of driving elements 219 for driving the plurality of covers 213 to open or close the plurality of mounting holes 212, and the plurality of driving elements 219 is connected to the intelligent terminal system.

The one end of the magnetic attraction sleeve 216 is provided with the connector 218, the magnetic attraction sleeve 216 is connected to the plurality of detection sleeves 211 through the connector 218. The magnetic attraction sleeve 216 is provided with the switch structure 2161 for controlling connection or disconnection between the connector 218 and the plurality of detection sleeves 211.

The adverse geology 7 refers to a collective term for various geological phenomena that affect tunnel construction. For example, the adverse geology 7 includes water inrush, cavities, fracture zones, faults, etc.

The protection system 21 refers to a module assembly configured to protect and transport the signal acquisition system 22.

The detection sleeve 211 refers to a tubular structure configured to accommodate and protect the detection mechanism 20 and deliver the detection mechanism 20 into the forepoling borehole 5. For example, the detection sleeve 211 is a hollow pipe.

The mounting hole 212 refers to a through hole for allowing the detection mechanism 20 to extend out of the detection sleeve 211. For example, the mounting hole 212 is a through hole provided in a side wall of the detection sleeve 211. In some embodiments, as shown in FIG. 2, the plurality of mounting holes 212 is arranged at equal intervals along a length direction of the plurality of detection sleeves 211.

The cover 213 refers to a component configured to block the mounting hole 212 to prevent damage to the detection mechanism 20 during a non-operational period. For example, the cover 213 is a cover plate disposed on an inner wall of the plurality of detection sleeves 211 near a corresponding mounting hole 212. The cover plate is driven by a corresponding driving element 219 to close or open the corresponding mounting hole 212.

The driving element 219 refers to an actuator installed inside the detection sleeve 211 and configured to drive the cover 213 to open or close the mounting hole 212. For example, the plurality of driving elements 219 include electric cylinder drive mechanisms, electromagnet drive mechanisms, linear motor drive mechanisms, etc.

In some embodiments, the plurality of driving elements 219 may be connected to the intelligent terminal system through a wired connection (e.g., a cable) or a wireless connection. Taking the wireless connection as an example, the plurality of detection sleeves 211 is provided with microcontroller units and communication antennas. The microcontroller units are connected to drive circuits of the plurality of driving elements 219 through internal wiring. The microcontroller units communicate with the intelligent terminal system through a wireless protocol (e.g., Wi-Fi, Bluetooth, or ZigBee, etc.). The intelligent terminal system may remotely control the plurality of driving elements 219 through the microcontroller units, thereby driving the plurality of covers 213 to open or close the plurality of mounting holes 212.

In some embodiments, the plurality of driving elements 219 may be miniature electric cylinders as needed. The miniature electric cylinders include push rods fixedly connected to the plurality of covers 213. The miniature electric cylinders drive the push rods to move, thereby driving the plurality of covers 213 to slide within the plurality of detection sleeves 211 along a length direction of the plurality of detection sleeves 211, thereby blocking the plurality of mounting holes 212 and reducing damage or impact from the external environment on a plurality of geophones. The length direction of the plurality of detection sleeves 211 may be represented by an arrow X in FIG. 2 and FIG. 3.

The magnetic attraction sleeve 216 refers to a tubular structure connected to the plurality of detection sleeves 211 through magnetic attraction force. After the magnetic attraction sleeve 216 is connected to the plurality of detection sleeves 211, a construction worker can convey the plurality of detection sleeves 211 into or pull the plurality of detection sleeves 211 out of the forepoling borehole 5 through the magnetic attraction sleeve 216. For example, the magnetic attraction sleeve 216 is a hollow pipe. The magnetic attraction sleeve 216 and the plurality of detection sleeves 211 are both provided with magnetic attachments, or the magnetic attraction sleeve 216 and the plurality of detection sleeves 211 are both made of ferromagnetic material.

The connector 218 refers to a component disposed at an end of the magnetic attraction sleeve 216 and configured to connect to or disconnect from the plurality of detection sleeves 211 under control of the switch structure 2161. For example, the connector 218 is a magnetic attachment disposed at one end in a length direction of the magnetic attraction sleeve 216. The connector 218 generates a magnetic force under control of the switch structure 2161 to connect to the plurality of detection sleeves 211, or loses the magnetic force under control of the switch structure 2161 to disconnect from the plurality of detection sleeves 211.

The switch structure 2161 refers to an actuator for controlling the connector 218 to connect to or disconnect from the plurality of detection sleeves 211. For example, both the connector 218 and the plurality of detection sleeves 211 are provided with the magnetic attachments. The switch structure 2161 may control the magnetic attachment of the connector 218 to generate the magnetic force or lose the magnetic force, thereby enabling the connector 218 to connect to or disconnect from the plurality of detection sleeves 211.

More descriptions regarding how the switch structure 2161 controls the connector 218 to connect to or disconnect from the plurality of detection sleeves 211 may be found in the related descriptions below.

The signal acquisition system 22 refers to a module assembly for contacting a rock mass and acquiring the seismic wave signal.

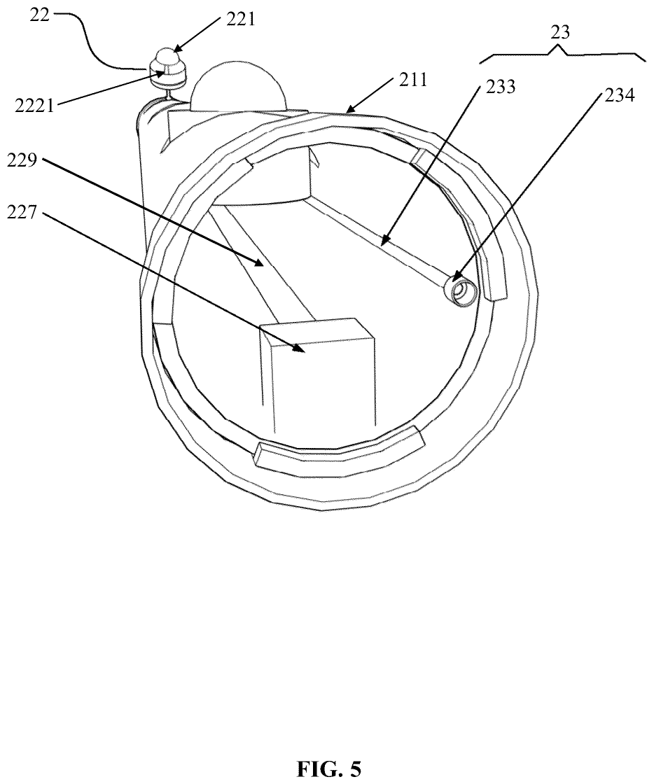

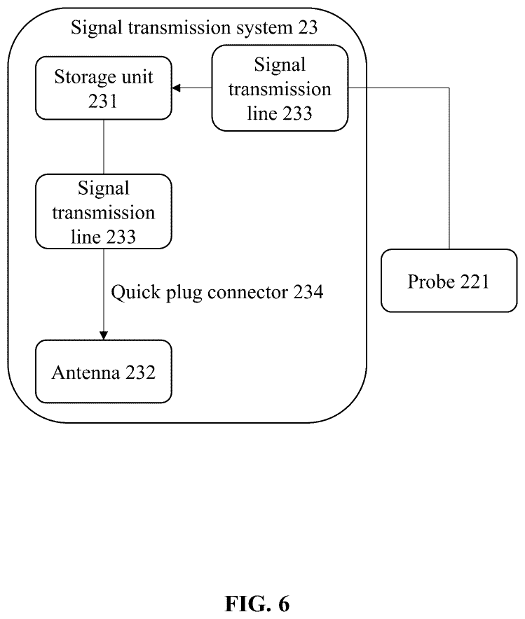

The signal transmission system refers to a module assembly for receiving and temporarily storing the seismic wave signal, and transmitting the seismic wave signal to the intelligent terminal system. More descriptions regarding the signal transmission system may be found elsewhere in the present disclosure (e.g., FIG. 5 to FIG. 6 and related descriptions thereof).

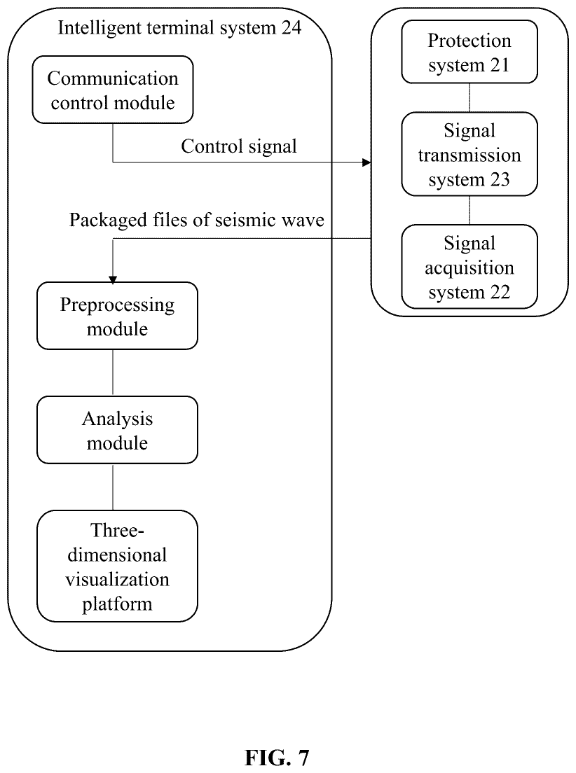

The intelligent terminal system refers to a module assembly responsible for remotely controlling operation of the detection device 2, receiving and processing the seismic wave signal, and ultimately generating a report regarding rock mass quality and adverse geology. The intelligent terminal system is composed of existing devices such as a parallel computing unit, an efficient storage device, and a professional software to achieve noise reduction and display of the seismic wave signal 6. More descriptions regarding the intelligent terminal system may be found elsewhere in the present disclosure (e.g., FIG. 7 and related descriptions thereof).

The following describes the operating principle of the detection device 2 provided by some embodiments of the present disclosure:

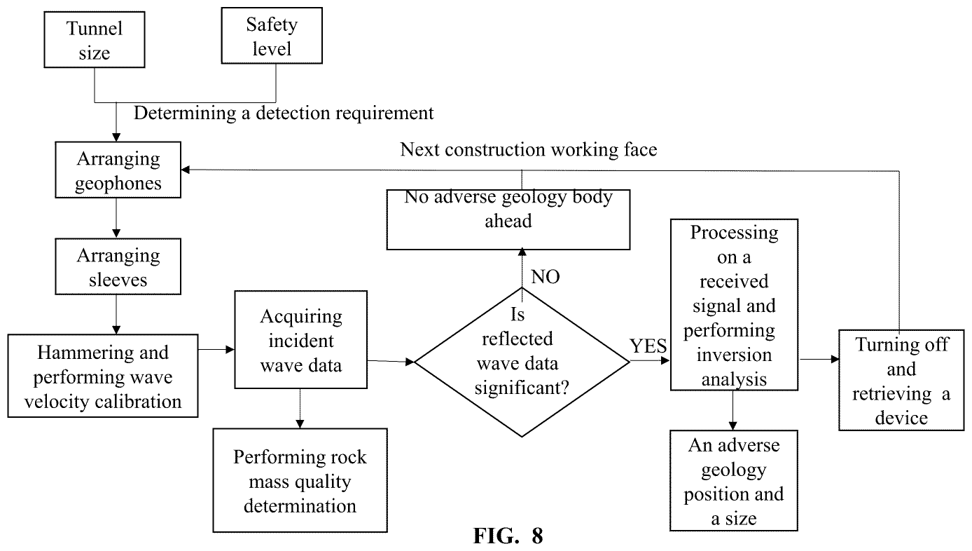

The construction worker splices the plurality of detection sleeves 211 according to a detection requirement, and installs the signal acquisition system 22 within the plurality of detection sleeves 211. The construction worker controls the switch structure 2161 to connect the magnetic attraction sleeve 216 to the plurality of detection sleeves 211, convey the plurality of detection sleeves 211 into the forepoling borehole 5 in front of the working face 4, control the switch structure 2161 to disconnect the magnetic attraction sleeve 216 from the plurality of detection sleeves 211, and remove the magnetic attraction sleeve 216. Blasting vibration during the tunnel excavation generates a seismic wave (an incident wave signal 31). When the seismic wave encounters an adverse geology body (e.g., a fault and water body), a reflected wave signal 32 is formed. The signal acquisition system 22 in the forepoling borehole 5 acquires the incident wave signal 31 and the reflected wave signal 32, and transmits the acquired signals to the intelligent terminal system through the signal transmission system. The intelligent terminal system processes and analyzes the signals, performs rock mass quality determination, and predicts an adverse geology 7 coordinate and an adverse geology size ahead. More descriptions regarding the operating principle of the detection device 2 may be found elsewhere in the present disclosure (e.g., FIG. 8 and related descriptions thereof).

Some embodiments of the present disclosure utilize the existing forepoling borehole 5 to arrange the plurality of detection mechanisms 20, eliminating the need for additional drilling and improving detection efficiency. The detection device 2 is disposed in front of the working face 4, closer to the adverse geology 7. A propagation path of the reflected wave is shorter, effective signal loss is less, and identification accuracy and precision for the adverse geology 7 are higher. The plurality of detection sleeves 211 described in the present disclosure are capable of being assembled to meet detection needs of different lengths, and facilitate transportation and portability.

In some embodiments, as shown in FIG. 2, a head end of each of the plurality of detection sleeves 211 is provided with a buckle 214, and a tail end of the each of the plurality of detection sleeves 211 is provided with a slot 215 adapted to the buckle 214. Adjacent detection sleeves 211 are snap-fitted together through the buckle 214 and the slot 215.

The head end and the tail end of the each of the plurality of detection sleeves 211 are two ends in the length direction of the each of the plurality of detection sleeves 211. One end of the detection sleeve 211 provided with the buckle 214 is the head end, and another end provided with the slot 215 is the tail end. The head end and the tail end of the each of the plurality of detection sleeves 211 are as shown in FIG. 2. When the plurality of detection sleeves 211 is assembled, a head end of a combination of the plurality of detection sleeves 211 is inserted into the forepoling borehole 5, and a tail end of the combination of the plurality of detection sleeves 211 is connected to the magnetic attraction sleeve 216.

Adapted refers to that a physical shape, size, or structure of one component is specifically designed to mate with another component. For example, a physical shape of the buckle 214 is complementary to a physical shape of the slot 215, thereby enabling a snap-fit function.

In some embodiments, two adjacent detection sleeves 211 are assembled through a threaded connection, a bolt-nut connection, a magnetic attraction connection, etc. For example, the head end of each of the plurality of detection sleeves 211 is provided with an internal thread, and the tail end of each of the plurality of detection sleeves 211 is provided with an external thread adapted to the internal thread.

In some embodiments of the present disclosure, the adjacent detection sleeves 211 are connected through the buckle 214 and the slot 215, facilitating assembly of the plurality of detection sleeves 211 and allowing the construction worker to assemble a count of the detection sleeves 211 according to a required length, thereby meeting detection requirements of different depths.

In some embodiments, as shown in FIG. 1 to FIG. 4, the switch structure 2161 includes a coil 21611. The coil 21611 is wound on an outer surface of the magnetic attraction sleeve 216. The other end of the magnetic attraction sleeve 216 is provided with a handle 217, the handle 217 is provided with a battery 21612 connected to the coil 21611, and the handle 217 is provided with a switch 21613 for controlling connection or disconnection between the battery 21612 and the coil 21611. The connector 218 and the plurality of detection sleeves 211 are made of the ferromagnetic material. The handle 217 is made of an insulating material.

The other end of the magnetic attraction sleeve 216 refers to one end of the magnetic attraction sleeve 216 away from the connector 218 along the length direction of the magnetic attraction sleeve 216.

After the coil 21611 is energized, the connector 218 generates the magnetic force, and the connector 218 and the plurality of detection sleeves 211 are adsorbed together by the magnetic force. The construction worker can convey the plurality of detection sleeves 211 into a required depth in the forepoling borehole 5 or remove the plurality of detection sleeves 211 from the forepoling borehole 5 through the magnetic attraction sleeve 216.

The handle 217 refers to a component for the construction worker to hold the magnetic attraction sleeve 216, thereby controlling movement of the plurality of detection sleeves 211. For example, the handle 217 may be a pull rod connected to the magnetic attraction sleeve 216.

In some embodiments, the handle 217 includes a housing. An interior of the housing is provided with a battery compartment adapted to the battery 21612 for fixing and accommodating the battery 21612. The battery 21612 includes a rechargeable battery (e.g., a lithium battery) or a pouch cell.

In some embodiments, the switch 21613 may be a physical button or a toggle switch disposed on a surface of the housing of the handle 217. A positive electrode and a negative electrode of the battery 21612 in the handle 217 are connected to an input terminal and an output terminal of the switch 21613 through battery wires, respectively. The input terminal and the output terminal of the switch 21613 are connected to two pins of the coil 21611 through switch wires, respectively. When the construction worker presses or toggles the switch 21613, the battery 21612 supplies power to the coil 21611, the connector 218 generates the magnetic force, and the magnetic attraction sleeve 216 attracts the plurality of detection sleeves 211. When the switch 21613 is turned off, the coil 21611 stops receiving power, the magnetic force of the connector 218 disappears, and the magnetic attraction sleeve 216 separates from the plurality of detection sleeves 211.

In some embodiments, the ferromagnetic material includes iron and alloys thereof, ferrite, etc. The connector 218 and the plurality of detection sleeves 211 are made of iron.

In some embodiments, the insulating material includes plastic, rubber, ceramic, etc. For example, the handle 217 is made of Acrylonitrile Butadiene Styrene (ABS) plastic.

Some embodiments of the present disclosure control the power supply and cutoff between the battery 21612 and the coil 21611 through the switch 21613, thereby causing the connector 218 to generate or lose the magnetic force. This allows the construction worker to conveniently connect the plurality of detection sleeves 211 and the magnetic attraction sleeve 216. By forming the handle 217 of the insulating material, the risk of electric shock to the construction worker is prevented. Furthermore, by integrating the battery 21612, the switch 21613, and the coil 21611 on the magnetic attraction sleeve 216, the need for an external power source or additional device is eliminated, thereby enhancing convenience.

In some embodiments, as shown in FIG. 1 to FIG. 4, the signal acquisition system 22 includes a plurality of geophones 220. The interior of the plurality of detection sleeves 211 is provided with a plurality of bases 225 for mounting the plurality of geophones 220. The plurality of bases 225 correspond one-to-one with the plurality of mounting holes 212. The plurality of geophones 220 is electrically connected to the plurality of bases 225. The plurality of bases 225 supply power to the plurality of geophones 220. The interior of the plurality of detection sleeves 211 is provided with a plurality of lifting elements 228 for driving the plurality of bases 225 to lift. The plurality of lifting elements 228 is connected to the intelligent terminal system. The intelligent terminal system controls the plurality of lifting elements 228 to lift. In some embodiments, the plurality of lifting elements 228 may be existing micro electric cylinders or micro telescopic actuators. The plurality of lifting elements 228 drive the plurality of geophones 220 to extend from the plurality of mounting holes of the plurality of detection sleeves 211, causing the plurality of geophones 220 to contact the wall of the forepoling borehole 5, thereby receiving the seismic wave signal 6. The interior of the plurality of detection sleeves 211 is provided with a battery pack 227. The battery pack 227 is connected to the plurality of bases 225 through a wire 229. The battery pack 227 is connected to the intelligent terminal system. The intelligent terminal system controls the turning on and off the battery pack 227. The plurality of geophones 220 is connected to the signal transmission system.

The base 225 refers to a component installed inside the detection sleeve 211, configured to carry and fix the geophone 220 and supply power thereto. For example, the base 225 is a truncated cone structure. One end of the plurality of bases 225 is connected to the inner wall of the plurality of detection sleeves 211 through the plurality of lifting elements 228, and the other end of the plurality of bases 225 is used for mounting the plurality of geophones 220. The geophone 220 is capable of detecting and acquiring the seismic wave signal 32 generated by the blasting during the tunnel excavation.

The shape of the plurality of bases 225 is adapted to the shape of the plurality of mounting holes 212. Each of the plurality of bases 225 is aligned with a respective mounting hole 212 on the each of the plurality of detection sleeves 211. The central axis of each of the plurality of bases 225 is aligned with the central axis of the respective mounting hole 212, ensuring that the each of the plurality of bases 225 can be extended from or retracted into the plurality of detection sleeves 211 through the corresponding mounting hole 212.

The lifting element 228 refers to an actuating mechanism for driving the base 225 to lift. For example, the each of the plurality of lifting elements 228 includes an electric push rod, a hydraulic or pneumatic cylinder, a linear motor, etc. Taking the electric push rod as an example, the electric push rod includes a motor, a push rod, and a screw-nut structure. One end of the push rod is fixed to a corresponding base 225, and the other end is connected to the nut. The motor drives the screw to rotate, thereby driving the nut to move along the screw, which in turn drives the push rod and the corresponding base 225 to lift and lower.

In some embodiments, a drive circuit of the each of the plurality of lifting elements 228 is connected to the aforementioned microcontroller unit through an internal wiring. The intelligent terminal system can remotely control the operation of the plurality of lifting elements 228 through the microcontroller unit, thereby driving the plurality of bases 225 to lift.

The battery pack 227 is electrically connected to the plurality of geophones 220 through the wire 229, the plurality of conductive bases 225 (also referred to as the plurality of bases 225), and a metal interface 2221, thereby supplying power to the plurality of geophones 220. In some embodiments, the battery pack 227 includes a battery management chip or circuit. The battery management chip or circuit is configured to control the connection or disconnection between the battery pack 227 and the wire 229. The battery management chip or circuit is connected to the aforementioned microcontroller unit. The intelligent terminal system can remotely control the battery pack 227 to supply power to or cut off power from the plurality of geophones 220. The intelligent terminal system can completely cut off power during transportation and storage of the detection device 2 for safety, and supply power when the detection device 2 is operating.

In some embodiments of the present disclosure, it is ensured that each geophone 220 can be accurately pushed out from the corresponding mounting hole 212 and contact the wall of the tunnel 1 by making the plurality of bases 225 correspond one-to-one with the plurality of mounting holes 212. The construction worker can arrange the plurality of geophones 220 within the plurality of detection sleeves 211 in varying numbers and at varying spacings based on different construction scales of the tunnel 1 and geological detection requirements, to achieve optimal detection results. The built-in battery pack 227 supplies power to the geophone 220, eliminating the need for the external power source. By connecting the plurality of lifting elements 228 and the battery pack 227 to the intelligent terminal system, remote control of the extending and retracting actions of the plurality of geophones 220, and their turning on and off, is achieved.

In some embodiments, the each of the plurality of geophones 220 includes a probe 221. An exterior of the probe 221 is provided with an insulating protective shell 222 (also referred to as the protective shell 222). The protective shell 222 is provided with the metal interface 2221 connected to the probe 221. The probe 221 is connected to a conductive mounting groove 226 (also referred to as the mounting groove 226) on the corresponding base 225 through the metal interface 2221. The mounting groove 226 is connected to the wire 229.

In some embodiments, the probe 221 is an existing geophysical probe. The geophysical probe mainly includes a housing, a mass block (a magnet), a probe coil, a spring, and a damper. The housing protects internal components and is typically made of sturdy metal or plastic to prevent influence from the external environment. The mass block is a magnet with a relatively large mass, suspended on the spring, and moves relative to the probe coil when the seismic wave passes through. The probe coil is wound around the mass block. When the mass block moves, an induced current is generated in the probe coil. The spring is used to suspend and stabilize the mass block, allowing it to move freely and quickly return to its equilibrium position. In some embodiments, a frequency response range of the probe 221 is between 1 Hz and 1000 Hz, and a sensitivity of the probe 221 is between 20 V/m/s and 100 V/m/s.

The protective shell 222 refers to a shell made of the insulating material, providing physical protection and electrical insulation for the geophone 220 disposed therein. For example, the protective shell 222 is a plastic shell.

The metal interface 2221 refers to an electrical connection port provided on the protective shell 222. For example, the metal interface 2221 may be a metal contact or a metal plug. After the plurality of geophones 220 is assembled with a plurality of mounting grooves 226, the plurality of conductive mounting grooves 226 is simultaneously electrically connected to a plurality of metal interfaces 2221 and the wire 229, and the battery pack 227 supplies power to the plurality of geophones 220.

The mounting groove 226 refers to a component configured to accommodate, fix, and electrically connect a corresponding geophone 220. For example, the mounting groove 226 is a groove or cavity formed in the plurality of bases 225.

In some embodiments, the plurality of mounting grooves 226 is made of a metal material or is provided with an electrical connection component to electrically connect with the plurality of metal interfaces 2221 and the wire 229. For example, the mounting groove 226 is a copper groove. Furthermore, the plurality of mounting grooves 226 is also connected to the signal transmission line described below, and is configured to transmit the seismic wave signal 6 acquired by a plurality of probes 221 to the signal transmission system.

In some embodiments of the present disclosure, the plurality of probes 221 is connected to the battery pack 227 and the signal transmission system 23 through the plurality of metal interfaces 2221, the plurality of conductive mounting grooves 226, and the wire 229. This design enables automatic establishment of power supply and signal pathways after the plurality of geophones 220 is assembled with the plurality of mounting grooves 226. Furthermore, this design allows each of the plurality of geophones 220, along with its protective shell 222 and metal interface 2221, to form a replaceable module, facilitating maintenance of the device.

In some embodiments, as shown in FIG. 2, an outer surface of a plurality of protective shells 222 is provided with rubber projection rings 223, the plurality of mounting grooves 226 are provided with grooves 224 adapted to the projection rings 223, and the plurality of geophones 220 is snap-fitted to the plurality of bases 225 through the engagement between the projection rings 223 and the grooves 224.

The plurality of geophones 220 are installed on the plurality of bases 225 by pressing the plurality of geophones 220 to insert the projection rings 223 into the grooves 224. During installation, the construction worker only needs to insert the plurality of geophones 220 into the plurality of mounting grooves 226. A clear resistance sensation occurs when the projection rings 223 slide into the grooves 224, indicating proper installation. During disassembly, the plurality of geophones 220 are detached from the plurality of mounting grooves 226 by applying a certain pulling force to the plurality of geophones 220. The connection between the plurality of geophones 220 and the plurality of mounting grooves 226 is achieved through the snap-fit structure of the projection ring 223 and the groove 224, facilitating easier installation and removal of the plurality of geophones 220.

In some embodiments, besides rubber, the material of the projection ring 223 may include silicone, thermoplastic polyurethane, nylon, etc.

In some embodiments, the plurality of geophones 220 may be connected to the plurality of bases 225 by means such as magnetic attraction connection, threaded connection, bolt connection, etc.

FIG. 5 is a schematic diagram illustrating a structure of an end of a detection sleeve according to some embodiments of the present disclosure. FIG. 6 is a schematic diagram of a connection between a signal transmission system and a probe according to some embodiments of the present disclosure.

In some embodiments, as shown in FIGS. 5 and 6, the signal transmission system 23 includes a storage unit 231 and an antenna 232. The storage unit 231 is connected to the plurality of probes 221 through a signal transmission line 233. The storage unit 231 is connected to the antenna 232 through the signal transmission line 233. The antenna 232 is connected to the signal transmission line 233 through a quick plug connector 234. The signal transmission line 233 is located inside the plurality of detection sleeves 211.

The storage unit 231 refers to a storage device configured to temporarily store the seismic wave signal and transmit the seismic wave signal to the intelligent terminal system. For example, the storage unit 231 may be a memory (e.g., flash memory chips) disposed inside the plurality of detection sleeves 211, or the storage unit 231 may be a storage device including a cloud computing platform (e.g., a public cloud).

The signal transmission line 233 refers to a dedicated cable disposed inside the plurality of detection sleeves 211, configured to transmit the seismic wave signal among the plurality of probes 221, the storage unit 231, and the antenna 232. For example, the storage unit 231 is connected to the plurality of probes 221 through the signal transmission line 233, the plurality of conductive mounting grooves 226, and the plurality of metal interfaces 2221, and receives the seismic wave signal acquired by the plurality of probes 221. As another example, the storage unit 231 is connected to the antenna 232 through the signal transmission line 233 and the quick plug connector 234, and transmits the seismic wave signal to the intelligent terminal system through the antenna 232.

In some embodiments, the quick plug connector 234 includes a male plug and a female plug. The male plug is fixed to the antenna 232. The female plug is fixed to the signal transmission line 233. When the male plug is inserted into the female plug, the antenna 232 is connected to the signal transmission line 233. When the male plug is separated from the female plug, the antenna 232 is disconnected from the signal transmission line 233.

In some embodiments of the present disclosure, the seismic wave signal acquired by the plurality of probes 221 is temporarily stored in the storage unit 231, and then transmitted to the intelligent terminal system by the antenna 232, thereby achieving data buffering and relaying and ensuring data integrity. Furthermore, the antenna 232 is connected to the signal transmission line 233 through the quick plug connector 234, achieving rapid connection and replacement of the antenna 232 and improving maintenance efficiency.

FIG. 7 is a schematic block diagram of an intelligent terminal system according to some embodiments of the present disclosure.

In some embodiments, as shown in FIG. 7, the intelligent terminal system 24 is constituted by existing computer system equipment such as an efficient central processing unit, a storage device, and a professional platform. In some embodiments, a communication control module of the intelligent terminal system 24 is configured to transmit control signals to other systems of the detection device 2, controlling corresponding components to perform corresponding functions. For example, the intelligent terminal system 24 communicates with the plurality of lifting elements 228 to control the plurality of lifting elements 228 to extend or retract. As another example, the intelligent terminal system 24 communicates with the battery pack 227 to control the battery pack 227 to turn on and off. As still another example, the intelligent terminal system 24 communicates with the plurality of driving elements 219 to control the plurality of covers 213 to open and close the plurality of mounting holes 212.

In some embodiments, a preprocessing module and an analysis module of the intelligent terminal system 24, using existing technology and leveraging a handheld tablet or a mobile phone sharing platform, are configured to remotely operate the detection device, view operation status information of the geophone in real time, and receive packaged files of sampled seismic wave (e.g., the seismic wave signal).

In some embodiments, the intelligent terminal system 24, using existing technology, is configured to generate adaptive sampling frequencies and resolutions for various detection parts within the tunnel based on first fine sampling information of the tunnel, balancing effective data storage and acquisition. The intelligent terminal system 24 efficiently and accurately identifies visualized graphics of the seismic wave using existing deep learning technology, and determines a type, a distance, and a risk level of potential adverse geology 7 ahead of the working face.

In some embodiments, the intelligent terminal system 24, using existing technology and based on a three-dimensional visualization platform, forms a three-dimensional image of defects by integrating information acquired by a single geophone 220 or the plurality of geophones 220. The intelligent terminal system 24 updates and improves a three-dimensional database as the tunnel advances forward, forming a three-dimensional geological information database for the area, providing reference for subsequent construction in similar areas.

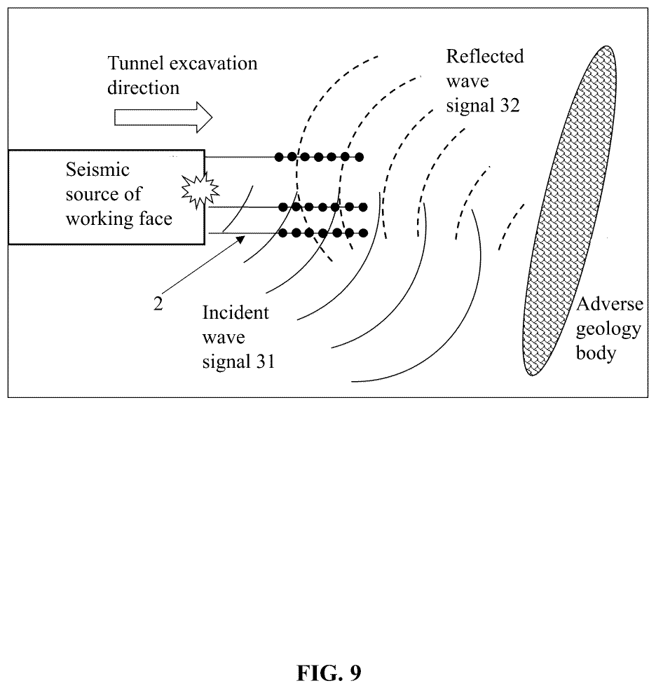

FIG. 8 is a flowchart illustrating a detection method according to some embodiments of the present disclosure. FIG. 9 is a schematic diagram illustrating an HSP manner according to some embodiments of the present disclosure.

As shown in FIG. 8 and FIG. 9, the present disclosure also provides a detection method. The detection method is implemented based on the device for passively detecting tunnel excavation adverse geology 2 described above. The detection method includes:

In S1, determining a detection requirement according to a tunnel size and a safety level, and determining a total length of the plurality of detection sleeves (e.g., the plurality of detection sleeves 211 described above).

The tunnel size refers to a size of a cross-section perpendicular to a tunnel excavation direction. For example, when a shape of the cross-section is circular, the tunnel size is a diameter of the cross-section. As another example, when the shape of the cross-section is rectangular, the tunnel size is a length and a width of the cross-section.

In some embodiments, a construction worker may obtain the tunnel size based on an engineering design drawing or on-site actual measurement.

The safety level refers to a risk classification for tunnel engineering design and construction. For example, if the tunnel engineering is a subway tunnel and an important building is present above the tunnel, the safety level is high.

In some embodiments, the construction worker may directly determine the safety level according to design and construction specifications issued by national, industry, or enterprise for the tunnel engineering.

The detection requirement refers to a performance indicator and a hardware configuration that the detection device 2 needs to possess to meet safety and accuracy requirements of a specific tunnel engineering. For example, the detection requirement includes a total length of the plurality of detection sleeves 211, a count of geophones (e.g., the plurality of geophones 220 described above), and a spacing between adjacent geophones, etc.

In some embodiments, the construction worker determines the total length of the plurality of detection sleeves 211 based on the tunnel size, determines a precision requirement based on the safety level, and then determines the count of the geophones 220 and the spacing between the adjacent geophones 220. For example, the greater the tunnel size is, the longer the total length of the plurality of detection sleeves 211 is; the higher the safety level is, the higher the precision requirement is, the greater the count of the geophones 220 is, and the smaller the spacing between the adjacent geophones 220 is.

In S2, assembling the plurality of detection sleeves 211, installing a plurality of geophones 220 in the plurality of detection sleeves 211, inspecting the plurality of geophones 220 to ensure normal operation of the plurality of geophones 220, and inserting the plurality of detection sleeves 211 into a forepoling borehole (e.g., the forepoling borehole 5 describe above).

For example, before installing the plurality of geophones 220, the construction worker may lift the plurality of bases (e.g., the plurality of bases 225 described above) by the plurality of lifting elements (e.g., the plurality of lifting elements 228 described above), causing the plurality of bases 225 to extend out of the plurality of mounting holes (e.g., the plurality of mounting holes 212 described above). After assembling the plurality of geophones 220 onto the plurality of bases 225, lower the plurality of bases 225 by the plurality of lifting elements 228, causing the plurality of geophones 220 to retract into the plurality of detection sleeves 211.

In S3, inserting a tail end of a combination of the plurality of detection sleeves 211 into a tail end of the connector (e.g., the connector 218 described above) of the magnetic attraction sleeve (e.g., the magnetic attraction sleeve 216 described above), turning on a switch (e.g., the switch 21613 described above), after a coil (e.g., the coil 21611 described above) is energized, generating a magnetic force by the connector 218, and fixing the connector 218 to the combination of the plurality of detection sleeves 211; conveying the plurality of detection sleeves 211 to a specific position in front of the working face 4 through the magnetic attraction sleeve 216; turning off the switch 21613; and removing the magnetic attraction sleeve 216 from the forepoling borehole 5.

The tail end of the connector 218 refers to an end of the connector 218 away from the construction worker when the construction worker holds the magnetic attraction sleeve 216.

In S4, controlling, by the intelligent terminal system (e.g., the intelligent terminal system 24 described above), a plurality of lifting elements 228 to extend. The plurality of lifting elements 228 extends a plurality of probes 221 of the plurality of geophones 220 out of the plurality of mounting holes 212 through the plurality of bases 225, and the plurality of probes 221 contacts a wall of the forepoling borehole 5.

In S5, hammering the working face 4 to perform wave velocity calibration of the plurality of geophones 220.

Before blasting, the intelligent terminal system 24 first determines positions of the plurality of geophones 220 based on positions of the plurality of detection sleeves 211, and obtains a propagation velocity of a seismic wave in a normal stratum through the wave velocity calibration. In some embodiments, obtaining the propagation velocity of the seismic wave in the normal stratum includes: the intelligent terminal system 24 identifies moments when a hammering pulse first arrives at the plurality of geophones 220 based on data from the plurality of geophones 220. The intelligent terminal system determines a propagation time of the hammering pulse based on a start time and an arrival time of the hammering pulse in recording data, and then determines the propagation velocity of the seismic wave in the normal stratum.

In S6, blasting the tunnel 1, receiving, by the plurality of geophones 220, an incident wave signal 31 and a reflected wave signal 32; and storing, by the plurality of geophones 220, the incident wave signal 31 and the reflected wave signal 32 in a storage unit (e.g., the storage unit 231 described above) through a signal transmission line (e.g., the signal transmission line 233 described above), and transmitting a signal to the intelligent terminal system 24 through an antenna (e.g., the antenna 232 described above).

The incident wave signal 31 refers to a seismic wave signal that is generated from a seismic source and propagates directly toward a detection target (e.g., in front of the working face 4). In a tunnel formed by a drilling and blasting manner, the seismic source is a blasting point during tunnel excavation. The incident wave signal 31 may be represented by the solid signal wave in FIG. 9.

The reflected wave signal 32 refers to a seismic wave signal that is received by the geophone 220 when a portion of the energy of an incident wave emitted from the seismic source is reflected during its propagation when the incident wave encounters a wave impedance contrast interface. The wave impedance contrast interface refers to an interface between two geological bodies with a significant wave impedance difference. For example, the wave impedance contrast interface may be an interface between a geological body, such as a water body, a cavity, etc., and the normal stratum. Wave impedance is the product of a density of a medium (i.e., the geological body) and a longitudinal wave velocity of the seismic wave. The reflected wave signal 32 may be represented by the dashed signal wave in FIG. 9.

In S7, performing, by the intelligent terminal system, preprocessing on a received signal, performing rock mass quality determination, and predicting an adverse geology 7 coordinate and an adverse geology size ahead.

The preprocessing refers to processing detection signals from the plurality of geophones 220 before performing the rock mass quality determination and predicting the adverse geology 7 coordinate and the adverse geology size ahead. For example, the preprocessing includes data unpacking and importing, noise reduction processing, gain recovery and energy compensation, etc. Merely by way of example, the data unpacking and importing includes that: the intelligent terminal system 24 receives the seismic wave signal acquired by the plurality of detection mechanisms 20, parses the seismic wave signal, and converts the seismic wave signal into time-series signal data processable by the system. The noise reduction processing includes that: the intelligent terminal system 24 performs band-pass filtering on the time-series signal data, retaining frequency band components consistent with an effective frequency range of the seismic wave. The gain recovery and energy compensation includes that: the intelligent terminal system 24 corrects and compensates an amplitude of the signals based on propagation attenuation characteristics of the seismic wave in the rock mass.

In S8, after completing one tunnel 1 detection, controlling, by the intelligent terminal system 24, the plurality of lifting elements 228 to descend, retracting the plurality of probes 221 into the plurality of detection sleeves 211; removing the plurality of detection sleeves 211 from the forepoling borehole 5 through the magnetic attraction sleeve 216; and disassembling the plurality of detection sleeves 211 and the plurality of geophones 220 to prepare for detection of a next construction working face 4.

Before removing the plurality of detection sleeves 211, the construction worker needs to turn on the switch 21613, causing the connector 218 to generate the magnetic force, thereby fixing the magnetic attraction sleeve 216 to the plurality of detection sleeves 211.

The detection device 2 described in the present disclosure can achieve two functions: performing adverse geology 7 prediction and performing the rock mass quality determination.

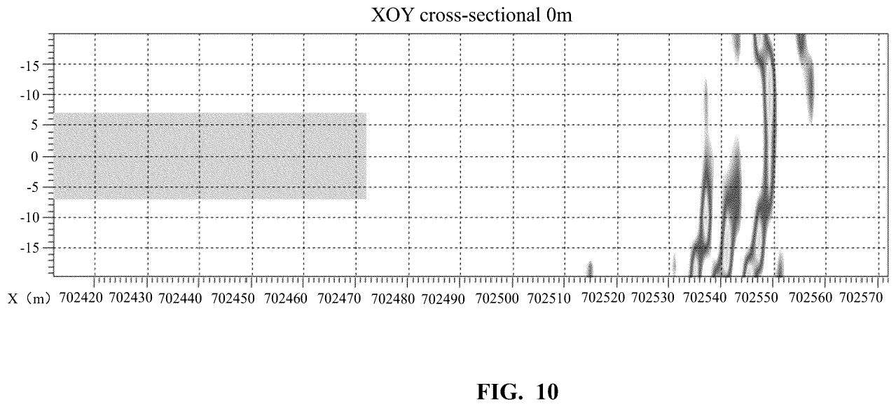

FIG. 10 is an XOY cross-sectional diagram illustrating an analysis result of a reflected wave according to some embodiments of the present disclosure.

Performing the adverse geology body prediction:

The method adopts a Horizontal Sounding Profiling (HSP) manner in seismic wave reflection, as shown in FIG. 1 and FIG. 9. This manner is based on elastic wave theory, and its propagation process follows the Huygens-Fresnel principle and Fermat's principle. A prerequisite for implementing this manner is the existence of a wave impedance difference between different media. Wave field propagation velocity, Particle vibration amplitude, etc., are closely related to the composition, density, structural characteristics, etc., of the medium. By utilizing the significant difference in wave impedance characteristics between geological bodies, such as fault fracture zones, karst caves, and groundwater, and the background stratum, the prediction of the adverse geology body is achieved. During the implementation of the HSP manner, based on characteristics of the tunnel 1 construction, the seismic wave signal 6 generated by blasting during the construction of the tunnel 1 is used as a prediction excitation signal for the HSP manner. Data acquisition is achieved through spatially arranging the plurality of geophones reception, and inversion analysis is performed through depth-domain diffraction scanning migration stacking imaging technology. The theoretical formula for HSP manner prediction is as follows:

$${R}_{12} = \frac{{ρ}_{2} {v}_{2} - {ρ}_{1} {v}_{1}}{{ρ}_{2} {ρ}_{2} + {ρ}_{1} {v}_{1}} .$$

In the formula: R₁₂ denotes a reflection coefficient; ρ₁, ρ₂ denote densities of different media, in units of kg/m³, v₁, v₂ denote longitudinal wave velocities of the seismic wave in the different media, in units of m/s.

After initiation in the drilling and blasting manner, the seismic incident wave generated by the blasting propagates forward in the tunnel 1. When the seismic incident wave encounters a geological body, such as a water body or a cavity, with a wave impedance significantly different from that of the normal stratum, it is reflected to generate a reflected wave. The reflected wave is received successively by the plurality of geophones located in a three-dimensional spatial field. The intelligent terminal system processes received waveform data through operations such as spectrum analysis, correlation interference analysis, and inversion imaging, and determines a time difference between the arrival of the incident wave and the reflected wave at the plurality of geophones. An azimuth coordinate and a size of the adverse geology body ahead are determined using a triangulation principle, completing geological prediction work and guiding the tunnel 1 construction.

The schematic formula for the positioning principle is as follows:

$${t}_{i} = \frac{\vert S - T \vert + \vert T - {G}_{i} \vert}{v} .$$

In the formula, S denotes a position of a seismic source, T denotes a position of the adverse geology body, Gᵢ denotes positions of the plurality of geophones, v denotes a wave velocity of the longitudinal wave, and tᵢ denotes a propagation time of the longitudinal wave.

For each of the plurality of geophones Gᵢ, given known coordinates of S and Gᵢ, a position of a reflection source is determined by applying an inversion algorithm using the tᵢ data from each geophone. An inversion model iteratively adjusts the position of the adverse geology body until an error between the determined propagation time tᵢ and the actual arrival time recorded by the each geophone is minimized, thereby obtaining the position T of the adverse geology body.

The analysis result of the reflected wave is shown in FIG. 10.

The rock mass quality determination:

For the rock mass quality determination function, since the detection device 2 is placed in front of the working face 4, by determining the time difference for the seismic wave generated by the seismic source to reach the plurality of geophones, a quality of the rock mass within a certain distance in front of the working face 4 can be determined. A theoretical prediction formula of the manner is as follows:

$${V}_{P} = \frac{\sqrt{K + \frac{4}{3} G}}{ρ} .$$

In the formula, V_{P} denotes a propagation velocity of the longitudinal wave of the seismic wave, K denotes a bulk modulus of a rock mass material, G denotes a shear modulus of the rock mass material, and ρ denotes a density of the rock mass material.

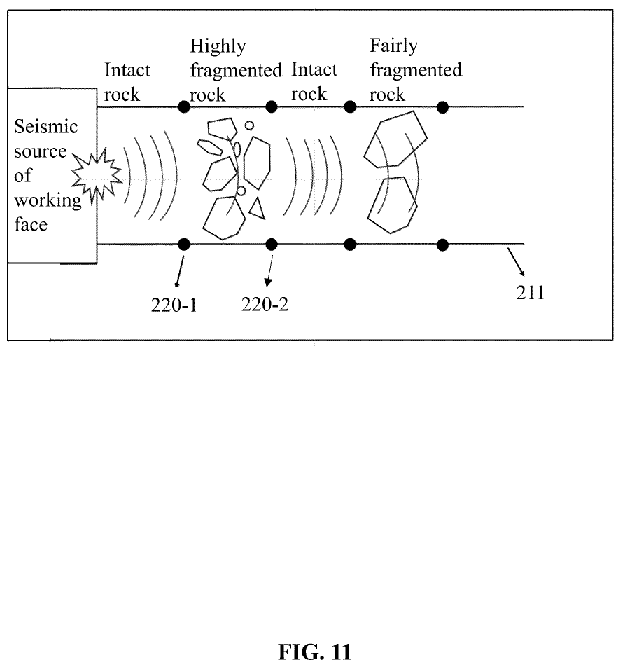

FIG. 11 is a schematic diagram illustrating a rock mass quality determination according to some embodiments of the present disclosure. As shown in FIG. 11, fragmented rock is composed of a plurality of irregular blocks. Contact between particles is not as tight as in intact rock. An interior of the fragmented rock contains numerous voids and contact interfaces. Compared with the intact rock, the bulk modulus K of the fragmented rock is lower. Therefore, a propagation velocity of the seismic wave in the fragmented rock area is less than a propagation velocity of the seismic wave in the intact rock area. The difference in the propagation velocity is manifested in signal acquisition as a difference in time for the plurality of geophones arranged at equal intervals to detect the seismic wave. For example, as shown in FIG. 11, there exists a fragmented rock area between a geophone 220-1 and a geophone 220-2, a time for the geophone 220-2 to detect the seismic wave is a first time. When there exists the intact rock between the geophone 220-1 and the geophone 220-2, a time for the geophone 220-2 to detect the seismic wave is a second time. With the same seismic source, the first time is greater than the second time. In principle, the more fragmented the rock is, the longer the time for the geophone 220-2 to detect the seismic wave is.

Some embodiments of the present disclosure transform a complex detection project into a series of clear, coherent, and operable steps, achieving process flow and standardization of the detection process. Step S4 and Step S5 provide dual guarantees for data acquisition quality, ensuring the accuracy and reliability of detection data. By explicitly utilizing vibration generated by construction itself as the seismic source in step S6, the method highlights the economy and efficiency of passive detection.

Therefore, by utilizing the device for passively detecting tunnel excavation adverse geology and the detection method described in the present disclosure, problems of complex structure, inconvenient use, and low detection accuracy of existing devices can be addressed.

Finally, it should be noted that the above embodiments are only used to illustrate the technical solutions of the present disclosure and not to limit them. Although the present disclosure has been described in detail with reference to the preferred embodiments, those skilled in the art should understand that they can still modify the technical solutions of the present disclosure or make equivalent replacements. These modifications or equivalent replacements cannot make the modified technical solutions depart from the spirit and scope of the technical solutions of the present disclosure.

What is claimed is:

1. A device for passively detecting tunnel excavation adverse geology, comprising: a plurality of detection mechanisms, wherein the plurality of detection mechanisms is disposed in a forepoling borehole located at a working face of a tunnel;
wherein the plurality of detection mechanisms includes a protection system, a signal acquisition system, a signal transmission system, and an intelligent terminal system, the signal acquisition system is disposed inside the protection system, the protection system is configured to protect the signal acquisition system, and the signal acquisition system is connected to the intelligent terminal system through the signal transmission system, and transmits an acquired signal to the intelligent terminal system for processing;
wherein the protection system includes a plurality of detection sleeves connected end to end and a magnetic attraction sleeve for conveying the plurality of detection sleeves into the forepoling borehole, each of the plurality of detection sleeves is provided with a mounting hole for allowing the signal acquisition system to extend out of a corresponding detection sleeve, the mounting hole is provided with a cover for sealing a corresponding mounting hole, an interior of each of the plurality of detection sleeves is provided with a driving element for driving a corresponding cover to open or close the corresponding mounting hole, and the driving element is connected to the intelligent terminal system; and
wherein one end of the magnetic attraction sleeve is provided with a connector, the magnetic attraction sleeve is connected to the plurality of detection sleeves through the connector, and the magnetic attraction sleeve is provided with a switch structure for controlling connection or disconnection between the connector and the plurality of detection sleeves.

2. The device for passively detecting tunnel excavation adverse geology according to claim 1, wherein:
a head end of each of the plurality of detection sleeves is provided with a buckle, a tail end of each of the plurality of detection sleeves is provided with a slot adapted to the buckle, and adjacent detection sleeves are snap-fitted through the buckle and the slot.

3. The device for passively detecting tunnel excavation adverse geology according to claim 1, wherein:
the switch structure includes a coil, the coil is wound on an outer surface of the magnetic attraction sleeve, the other end of the magnetic attraction sleeve is provided with a handle, the handle is provided with a battery connected to the coil, and the handle is provided with a switch for controlling connection or disconnection between the battery and the coil; and
the connector and the plurality of detection sleeves are made of a ferromagnetic material, and the handle is made of an insulating material.

4. The device for passively detecting tunnel excavation adverse geology according to claim 1, wherein:
the signal acquisition system includes a plurality of geophones, an interior of the plurality of detection sleeves is provided with a plurality of bases for mounting the plurality of geophones, the plurality of bases corresponds one-to-one to a plurality of mounting holes, the plurality of geophones are electrically connected to the plurality of bases, the interior of the plurality of detection sleeves is provided with a plurality of lifting elements for driving the plurality of bases to lift, the plurality of lifting elements are connected to the intelligent terminal system, the interior of the plurality of detection sleeves is provided with a battery pack, the battery pack is connected to the plurality of bases through a wire, the battery pack is connected to the intelligent terminal system, and the plurality of geophones are connected to the signal transmission system.

5. The device for passively detecting tunnel excavation adverse geology according to claim 4, wherein:
each of the plurality of geophones includes a probe, an exterior of the probe is provided with an insulating protective shell, the insulating protective shell is provided with a metal interface connected to the probe, the probe is connected to a conductive mounting groove on one of the plurality of bases through the metal interface, and the conductive mounting groove is connected to the wire.

6. The device for passively detecting tunnel excavation adverse geology according to claim 5, wherein:
an outer surface of the insulating protective shell is provided with a rubber projection ring, the conductive mounting groove is provided with a groove adapted to the rubber projection ring, and the plurality of geophones are snap-fitted to the plurality of bases through the rubber projection ring and the groove.

7. The device for passively detecting tunnel excavation adverse geology according to claim 5, wherein:
the signal transmission system includes a storage unit and an antenna, the storage unit is connected to the probe through a signal transmission line, the storage unit is connected to the antenna through the signal transmission line, the antenna is connected to the signal transmission line through a quick plug connector, and the signal transmission line is located inside the plurality of detection sleeves.

8. A detection method, implemented based on the device for passively detecting tunnel excavation adverse geology according to claim 1, wherein the detection method comprises:
S1. determining a detection requirement according to a tunnel size and a safety level, and determining a total length of the plurality of detection sleeves;
S2. assembling the plurality of detection sleeves, installing a plurality of geophones in the plurality of detection sleeves, inspecting the plurality of geophones to ensure normal operation of the plurality of geophones, and inserting a plurality of detection sleeves into the forepoling borehole;
S3. inserting a tail end of a combination of the plurality of detection sleeves into an end of the connector of the magnetic attraction sleeve, turning on a switch, wherein after a coil is energized, the connector generates a magnetic force, and the connector is fixed to the magnetic attraction sleeve; conveying the plurality of detection sleeves to a specific position in front of the working face through the magnetic attraction sleeve; turning off the switch; and removing the magnetic attraction sleeve from the forepoling borehole;
S4. controlling, by the intelligent terminal system, a plurality of lifting elements to extend, wherein the plurality of lifting elements extends a plurality of probes of the plurality of geophones out of a plurality of mounting holes through a plurality of bases, and the plurality of probes contacts a wall of the forepoling borehole;
S5. hammering the working face to perform wave velocity calibration of the plurality of geophones;
S6. blasting the tunnel, wherein the plurality of geophones receives an incident wave signal and a reflected wave signal; and storing, by the plurality of geophones, the incident wave signal and the reflected wave signal in a storage unit through a signal transmission line, and transmitting a signal to the intelligent terminal system through an antenna;
S7. performing, by the intelligent terminal system, preprocessing on a received signal, performing rock mass quality determination, and predicting an adverse geology coordinate and a adverse geology size ahead; and
S8. after completing one tunnel detection, controlling, by the intelligent terminal system, the plurality of lifting elements to descend, wherein the plurality of probes are retracted into the plurality of detection sleeves; removing the plurality of detection sleeves from the forepoling borehole through the magnetic attraction sleeve; and disassembling the plurality of detection sleeves and the plurality of geophones to prepare for detection of a next construction working face.
